(19) United States
(12) Patent Application Publication
(10) Pub. No.: US 2003/0026461 A1
(43) Pub. Date: Feb. 6, 2003

(54) Recognition and identification apparatus

(76) Inventor: Andrew Arthur Hunter, Bristol (GB)

Correspondence Address: HEWLETT-PACKARD COMPANY, Intellectual Property Administration, P.O. Box 272400, Fort Collins, CO, 80527-2400, US

(21) Appl. No.: 10/206,941

(22) Filed: Jul. 30, 2002

(30) Foreign Application Priority Data
Jul. 31, 2001 (GB) 0118599.0

(51) Int. Cl. G06K 9/00

(52) U.S. Cl. 382/114

(57) ABSTRACT

A method and apparatus for identifying features are described. The presence of one or more predetermined features is determined and details of one or more predetermined features are stored. A unique audible signal is then assigned to the or each of said predetermined features. This unique signal associated with the or each matched feature is then emitted to indicate the presence of the feature.

### FIELD OF THE INVENTION

This invention relates to apparatus for recognition and identification of living entities and inanimate objects, and in particular, to apparatus for aiding blind and partially blind people in the recognition and identification of such entities and objects.

### BACKGROUND OF THE INVENTION

It is well known that blind and partially blind people often compensate for their lack of sight, at least to some degree, by using their non-visual senses, in particular their senses of touch and hearing, to identify living entities and inanimate objects in their surroundings. In addition, they often memories the layout of a room or other environment so that they can move around that environment relatively freely without bumping in to any obstacles such as furniture or the like.

However, the sense of touch is only useful for identifying objects or living entities which are within the reach of a blind person. Similarly, their sense of hearing is of little use in recognising a person, animal or object which is substantially silent.

Traditionally, blind people have used white canes to extend their reach so that they can detect obstacles in front of them up to a distance equal to the length of the cane and the length of their arm. However, such devices are of limited use in actually identifying such obstacles. More recently, arrangements have been developed which emit ultrasonic waves and use reflections of such waves to detect obstacles. These arrangements are adapted to convert the reflected waves into audible signals and/or into movements of an electronic cane guide a blind person around an obstacle. As such, this type of arrangement operates to detect single nearby obstacles which might otherwise pose a hazard to the user whilst walking. However, no means are provided to actually identify the obstacle.

U.S. Pat. No. 6,055,048 describes an optical-to tactile translator which provides an aid for the visually impaired by translating a near-field scene to a tactile signal corresponding to the near-field scene. The device comprises an optical sensor for converting an image into a digital signal from which a shape signal is generated. This shape signal is then converted to a tactile signal representative of the image and conveyed to the user. The user is thereby made aware of the unseen near-field scene, including potential obstacles or dangers, through a series of tactile contacts.

Japanese patent application number JP 10069539A describes a similar arrangement in which images of a user's surroundings are captured by a camera and converts them into tactile signals, which are conveyed to a visually impaired user to enable them to understand their surroundings.

We have now devised an improved arrangement.

### SUMMARY OF THE INVENTION

Thus, in accordance with a first aspect of the present invention, there is provided apparatus for identifying features, the apparatus comprising recognition apparatus for recognising or determining the presence of one or more predetermined features, a first storage device for storing details of one or more predetermined features, the or each of said predetermined features having associated therewith a unique audible signal, matching apparatus for matching said recognised feature with the corresponding details stored in said first storage device, and an emitter for emitting the unique signal associated with the or each matched feature.

Also in accordance with the first aspect of the present invention, there is provided a method of identifying features, the method comprising the steps of recognising or determining the presence of one or more predetermined features, storing details of one or more predetermined features, assigning to the or each of said predetermined features, a unique audible signal, and emitting the unique signal associated with the or each matched feature.

Thus, the present invention provides a system for use in particular (but not necessarily) by blind and partially blind people, whereby specific objects, living entities and locations are recognised and identified to the user by a unique audible signal. The living entities could be specific people known to the user, or types of people, such as police officers and the like. The objects could be specific shops, roads, pedestrian crossings, etc. The locations could be specific road junctions, for example. Some types of objects, entities and, at least types of locations could be pre-programmed for general use, whereas other objects and entities could be programmed into or ‘learned’ by the system for specific users. Such “learning” of new objects/entities/locations and assignment of corresponding signals may be achieved by manual selection from a menu of signals when the object/entity/location to be “learned” is present by utterance of a spoken signal to be recorded and used as the signal (perhaps until such time as an alternative signal is assigned).

The recognition means may comprise an image capturing device (such as a video camera or the like), whereby the storage device stores details of one or more predetermined features (i.e. entities, objects and/or locations), and the apparatus further comprises matching apparatus for determining whether any of the features in images captured by one image capturing devices match the stored predetermined entities, objects or locations. In another embodiment, the recognition apparatus may comprise a global positioning system (GPS), and the storage device may store a map (or equivalent). In this case, the apparatus preferably comprises a compass or the like to orient the user relative to the map. In yet another embodiment, the objects, entities or locations to be recognised may be provided with a remotely detectable tag or marker and the recognition apparatus comprises a detector for detecting the tag, means being provided for determining the object, entity or location in or on which a tag has been identified. In this case, a transmitter may be provided for transmitting an enquiry signal towards an object, entity or location, the tag or marker being provided with a transmitter arranged to transmit a response signal back, possibly indicating data indicating the identity of the corresponding object, entity or location. The transmitter may be arranged to transmit data to the tag or marker, such data including, for example, information relating to the user of the apparatus.

In one preferred embodiment of the invention, the system could be arranged to ‘find’ one or more specific objects or entities and only emit those signals associated therewith. For example, if the user has arranged to meet a specific person, the system could be arranged to search the images captured thereby for that person and emit their associated signal only when that person is recognised. For this purpose, the apparatus may include an input device to enable a user to input one or more specific entities, objects or locations to be identified. Other pre-programmed objects and entities would effectively be ignored.

Accordingly, in accordance with a second aspect of the present invention, there is provided apparatus for identifying an entity or location, the apparatus comprising an image capturing device, a storage device for storing details of one or more entities or locations, the or each said entity or location having a unique audible signal associated therewith, the apparatus further comprising an input device for enabling a user to select or input one or more specific entities or locations, a recognition system for identifying said one or more specific entities or locations within images captured by said image capturing device, and an output device for emitting only the unique signal of the or each selected or input entity or location as it is recognised. Thus, the apparatus of the present invention is able, not only to alert a user as to the presence of an object or entity, but also provide its specific identity. It is also able to conduct a search for a specific entity or object.

Alternatively, the system could be arranged to emit the associated signals for all preprogrammed objects and entities as and when they are recognised. The system may provide means whereby the user can disable, delay or acknowledge the signals emitted thereby. It may also provide means whereby the user can select a ‘snooze’ function, which has the effect of stopping the signal being emitted and restarting it after a predetermined period of time if the object or entity associated therewith is still within the field of view of the image capturing device.

In yet another embodiment, the apparatus may be used in a vehicle, to signal, for example, the presence and position of a bicycle, pedestrian or other hazard near the vehicle. For instance, the apparatus may be arranged to emit a signal which sounds by a bicycle bell seeming to come from the direction of the bicycle detected in the driver's blind spot or perhaps behind the vehicle. In a further embodiment, the apparatus may be used to warn a cyclist of vehicles approaching him from behind. In this case, the apparatus may comprise a rear facing image capture device and audio signal generator(s) incorporated within a cycling helmet or the like.

In one embodiment of the present invention, the apparatus may be arranged to transmit data including information relating to the user of the apparatus to a recognised entity. For example, the apparatus may transmit information to a vehicle indicating that the user is impaired, or it may transmit information to a cyclist indicating that the vehicle it is in is located at a hidden junction.

Accordingly, in accordance with a third aspect of the invention, there is provided data transmission apparatus comprising an image recognition system for identifying the presence of an entity, an output device for emitting a unique audible signal in response to identification of the presence of said entity, and a transmitter for transmitting data to said entity.

The recognition apparatus is beneficially mounted in a user-wearable device. In one preferred embodiment, the image capturing device may be mounted in a head-mountable device, for example, a pair of dark glasses or the like to be worn by the user. The video sequence captured by the camera is beneficially fed to a portable image recognition and tracking system.

The system preferably further comprises at least one, and beneficially two, earpieces to be worn on or in the user's ears through which the signals are played in response to recognition of a particular object or entity. In one preferred embodiment of the invention, means are provided for varying the tempo, volume and/or stereo positioning of the emitted signal to convey position and movement of the respective object or entity. Thus, for example, in the case where the system is arranged to recognise people for which it has been ‘trained’, unique signature tunes may be played quietly while they are within the field of view of the image capturing device, with the volume and/or tempo increasing as they move closer to the user and fading away (or slowing down) as they move out of the filed of view. The signal may also be arranged to shift from one earpiece to the other as a person moves across the field of view of the image capturing device.

The system may be further enhanced by being adapted to associate specific signals with specific locations on a stored map to aid the user in finding their way around. For example, when a specific road junction enters the field of view of the image capturing device, the system may be arranged to play a specific theme tune or output a vocal indication of that road junction, played in a direction (using the earpieces) and at a volume determined by the direction and distance of that junction or the next junction or landmark on a route, relative to the user, the latter being particularly useful, for example, guiding a blind person to a particular locality in an unfamiliar town or for providing a route guidance function in a vehicle without the need for visual displays which could distract the driver. This information may be obtained by means of a positioning system such as GPS or the like. In one embodiment of the invention, an audible signal could be associated with an extended object, such as a selected route through a building or a long distance footpath, the system preferably being arranged to vary the strength of the signal so that it becomes stronger, say, as the user of the apparatus strays away from the selected route.

### BRIEF DESCRIPTION OF THE DRAWINGS

An embodiment of the invention will now be described by way of example only and with reference to the accompanying drawings in which:

FIG. 1 is a schematic block diagram of an exemplary embodiment of the present invention; and

FIG. 2 is a flow diagram illustrating a method according to an exemplary embodiment of the invention.

### DETAILED DESCRIPTION OF THE INVENTION

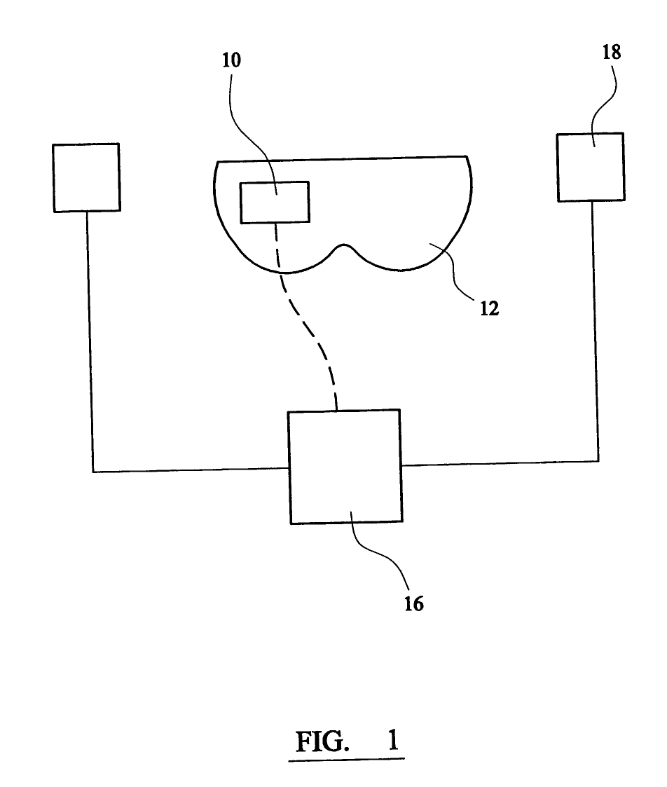

Referring to FIG. 1, apparatus according to an exemplary embodiment of the present invention comprises a digital video camera 10 mounted in a pair of dark glasses 12 worn by a user. The digital video camera 10 transmits a digital video signal to a portable computer 16 (by means of a hard-wired connection or a wireless connection such as Bluetooth™ or the like), the portable computer 16 running an image analysis program in which is stored details of a plurality of different objects and living entities required to be recognised, together with their associated unique audio signals (such as tunes).

The image analysis program may be chosen from, or may utilise, a number of conventional image recognition programs suitable for the purpose. One of the more difficult recognition problems is that of face recognition and identification—examples of appropriate face identification systems will now be discussed. A leading example is the MIT face recognition system developed by the Vision and modeling group of the MIT Media Lab.

Examples of existing software which is able to identify a face from an image is as follows:

Beyond Eigenfaces: Probabilistic Matching for Face Recognition Moghaddam B., Wahid W. & Pentland A. International Conference on Automatic Face & Gesture Recognition, Nara, Japan, April 1998.

Probabilistic Visual Leaming for Object Representation Moghaddam B. & Pentland A. Pattern Analysis and Machine Intelligence, PAMI-19 (7), pp. 696-710, July 1997

A Bayesian Similarity Measure for Direct Image Matching Moghaddam B., Nastar C. & Pentland A. International Conference on Pattern Recognition, Vienna, Austria, August 1996. Bayesian Face Recognition Using Deformable Intensity Surfaces Moghaddam B., Nastar C. & Pentland A. IEEE Conf. on Computer Vision & Pattern Recognition, San Francisco, Calif., June 1996.

Active Face Tracking and Pose Estimation in an Interactive Room Darrell T., Moghaddam B. & Pentland A. IEEE Conf. on Computer Vision & Pattern Recognition, San Francisco, Calif., June 1996.

Generalized Image Matching: Statistical Learning of Physically-Based Deformations Nastar C., Moghaddam B. & Pentland A. Fourth European Conference on Computer Vision, Cambridge, UK, April 1996.

Probabilistic Visual Learning for Object Detection Moghaddam B. & Pentland A. International Conference on Computer Vision, Cambridge, Mass., June 1995.

A Subspace Method for Maximum Likelihood Target Detection Moghaddam B. & Pentland A. International Conference on Image Processing, Washington D.C., October 1995.

An Automatic System for Model-Based Coding of Faces Moghaddam B. & Pentland A. IEEE Data Compression Conference, Snowbird, Utah, March 1995.

View-Based and Modular Eigenspaces for Face Recognition Pentland A., Moghaddam B. & Starner T. IEEE Conf. on Computer Vision & Pattern Recognition, Seattle, Wash., July 1994.

The MIT system includes a face identification component. However a separate system purely for face detection (without recognition) is the CMU (Carnegie Mellon University) face detector. A reference to this system is:

Human Face Detection in Visual Scenes, Henry A. Rowley, Shumeet Baluja and Takeo Kanade, Carnegie Mellon Computer Science Technical Report CMU-CS-95-158R, November 1995.

The image analysis program searches the received video images for images of the objects and living entities stored therein, and tracks these objects and entities within the field of view of the video camera 10. At the same time, the tune or other audio signal associated with each of the recognised features is played in stereo through a pair of earpieces 18 worn by the user. As the user gets closer to the recognised feature(s) or the feature(s) get closer to them, the volume of the played signal increases. Similarly, as the distance between the user and the recognised feature(s) increases, so the volume of the emitted signal decreases until a feature moves out of the field of view altogether, at which point the signal for that feature ceases to be played.

The locations of such objects/entities may be associated with a “map” of the surroundings of the user such that their positions can be remembered even when they are out of the field of view of the camera 10. The “map” might be periodically refreshed as the user moves the video camera 10 around the area. In this case, the respective signals can be generated such that they seem to come from objects/entities all around the user, even if they are only recognised and their positions detected or updated when the user turns his head towards them.

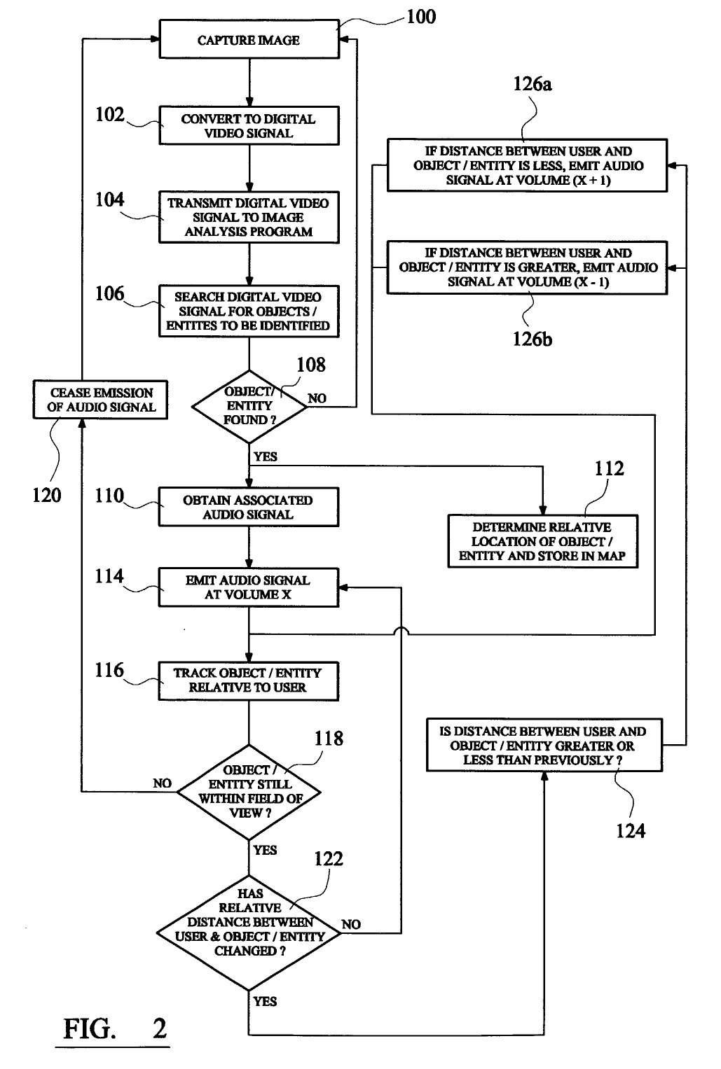

Thus, referring to FIG. 2 of the drawings, method according to an exemplary embodiment of the invention is illustrated. At step 100, an image within the camera's field of view is captured. The image is converted, at step 102, to a digital video signal, and the digital video signal is transmitted, at step 104, to the image analysis program running on potable computer 10. At step 106, the image analysis program searches the digital video signal for objects/entitles to be identified. These objects/entities may comprise a plurality of such objects/entities pre-programmed into a storage device for general use, or may comprise one or more specific objects/entities input or selected by the user.

Thus, the method determines, at step 108, if an object/entity to be identified is determined to be present in the captured image. If not, the method returns to step 100, at which another image is captured. If, however, an object/entity to be identified is determined to be present in the captured image, the associated audio signal is obtained (at step 110) and emitted (at step 114) at a predetermined volume X. In addition, the location of the identified object/entity relative to the user is determined and stored in a “map” of the surroundings of the user, such that its position can be remembered even when it is out of the field of view of the camera 10.

Furthermore, at step 116, the identified object/entity is tracked relative to the user (such that the location of the object/entity relative to the user can be monitored in the event of movement of either the user or the object/entity in question. At step 118, the method determines periodically whether or not the identified object/entity is still within the field of view of the camera 10. If not, emission of the associated audio signal is determined (at step 120) and the method returns to step 100, at which further images are captured. If, however, the identified object/entity is still within the field of view of the camera 10, the method determines (at step 122) if the relative distance between the user and the object/entity has changed. If not, method returns to step 114 and the audio signal continues to be emitted at the predetermined volume X. If, however, the relative distance between the user and the object/entity has changed, the method determines, at step 124, if the relative distance between the user and the object/entity is greater or less than previously. If it is greater, the audio signal is emitted at a lower volume (X−1) (step 126); if it is less, the audio signal is emitted at a greater volume (X+1) (step 126a), thereby indicating to the user that the relative distance between them and the object/entity in question has changed.

In the foregoing specification, the invention has been described with reference to specific exemplary embodiments thereof. It will, however, be apparent to a person skilled in the art that various modifications and changes may be made thereto without departing from the broader spirit and scope of the invention as set forth in the appended claims. Accordingly, the specification and drawings are to be regarded in an illustrative, rather than a restrictive, sense.

1. Apparatus for identifying features, the apparatus comprising recognition apparatus for recognizing or determining the presence of one of more predetermined features, a first storage device for storing details of one or more predetermined features, the or each of said predetermined features having associated therewith a unique audible signal, matching apparatus for matching said recognized feature with the corresponding details stored in said first storage device and an emitter for emitting the unique signal associated with the or each matched feature.

2. Apparatus according to claim 1, wherein said predetermined features relate to one or more living entities.

3. Apparatus according to claim 1, wherein said predetermined features relate to one or more inanimate objects.

4. Apparatus according to claim 1, wherein said predetermined features relate to one or more locations.

5. Apparatus according to claim 1, including at least one image capturing device.

6. Apparatus according to claim 5, including search apparatus for searching images captured by said at least one image capturing device and emitting the unique signal associated only with a chosen one or more of said predetermined features.

7. Apparatus according to claim 5, arranged to emit the associated unique signals for all pre-programmed features as and when they are recognized within the images captured by the at least one image capturing device.

8. Apparatus according to claim 1, comprising a second storage device for storing a plurality of signals for selection and assignment to a predetermined feature, as required.

9. Apparatus according to claim 1, wherein the recognition apparatus comprising an image capturing device and image matching apparatus for determining whether any of the features in a captured image match said predetermined features stored in said first storage device.

10. Apparatus according to claim 5, wherein said image capturing device comprises a video camera.

11. Apparatus according to claim 10, wherein said video camera is mounted in or on a user-wearable device.

12. Apparatus according to claim 9, wherein the image capturing device is mounted or incorporated in a head-mountable device.

13. Apparatus according to claim 12, wherein said head-mountable device is a pair of eyeglasses.

14. Apparatus according to claim 9, wherein images captured by said image capturing device are fed to a portable image recognition and tracking system.

15. Apparatus according to claim 1, wherein said recognition apparatus comprises a global positioning system, and said first storage device has stored therein a map (or equivalent)

16. Apparatus according to claim 1, wherein the features to be recognized are provided with a remotely detectable tag or marker, the recognition apparatus further comprising a detector for detecting a tag or marker and determining the identity of the respective feature.

17. Apparatus according to claim 16, comprising a transmitter for transmitting an enquiry signal towards a feature, the tag or marker being arranged to transmit a response signal back to the apparatus.

18. Apparatus according to claim 11, wherein said response signal includes data relating to the identity of the respective feature.

19. Apparatus according to claim 1, comprising at least one ear piece to be worn or in the user's ear through which the signals are played in response to recognition of a particular feature.

20. Apparatus according to claim 19, comprising two ear pieces.

21. Apparatus according to claim 1, comprising apparatus for varying the volume and/or stereo positioning of an emitted signal to convey position and/or movement of a respective feature.

22. Apparatus according to claim 1, wherein said unique signals comprise musical themes or tunes, a different theme or tune being associated with each predetermined feature.

23. Apparatus according to claim 1, comprising an input device for enabling a user to input one or more specific features, the apparatus being arranged to emit only the unique signals associated with said one or more specific features when they are recognized.

24. Apparatus according to claim 1, including a transmitter for transmitting information to a recognized feature.

25. Apparatus according to claim 1, located in or on a vehicle, and arranged to emit audible signals representative of respective hazards determined to be present in the vicinity of said vehicle.

26. A method of identifying features, the method comprising the steps of recognising or determining the presence of one or more predetermined features, storing details of one or more predetermined features, assigning to the or each of said predetermined features a unique audible signal, and emitting the unique signal associated with the or each matched feature.

27. Apparatus for identifying an entity or location, the apparatus comprising an image capturing device, a storage device for storing details of one or more entities or locations, the or each said entity or location having a unique audible signal associated therewith, the apparatus further comprising an input device for enabling a user to select or input one or more specific entities or locations, a recognition system for identifying said one or more specific entities or locations within images captured by said image capturing device, and an output device for emitting only the unique signal of the or each selected or input entity or location as it is recognised.

28. Data transmission apparatus comprising an image recognition system for identifying the presence of an entity, an output device for emitting a unique audible signal in response to identification of the presence of said entity, and a transmitter for transmitting data to said entity.

29. Apparatus according to claim 9, including a receiver for receiving data transmitted by said entity.

30. Apparatus according to claim 29, wherein an entity to be recognised is provided with a remotely detectable tag or marker, and the recognition system is arranged to detect said tag or marker to determine the identity of said entity.

31. Apparatus according to claim 1, wherein the tag or marker is arranged to transmit data to said apparatus.

32. Apparatus according to claim 28, wherein said data transmitted to said entity includes information relating to a user of said apparatus.
